(19) United States
(12) Patent Application Publication
(10) Pub. No.: US 2023/0013864 A1
(43) Pub. Date: Jan. 19, 2023

(54) CURRENT COLLECTOR ASSEMBLY, BATTERY CELL AND BATTERY PACK

(71) Applicant: XIAMEN HITHIUM NEW ENERGY TECHNOLOGY CO., LTD., Xiamen (CN)

(72) Inventors: Long ZHOU, Xiamen (CN); Xichong ZHANG, Xiamen (CN); Feng HU, Xiamen (CN); Yuyuan WU, Xiamen (CN); Min GUO, Xiamen (CN)

(21) Appl. No.: 17/864,441

(22) Filed: Jul. 14, 2022

(30) Foreign Application Priority Data
Jul. 14, 2021 (CN) 202110796493.4

(51) Int. Cl. H01M 50/536; H01M 50/534

(52) U.S. Cl. CPC H01M 50/536; H01M 50/534

(57) ABSTRACT

The present disclosure discloses a current collector assembly, a battery cell, and a battery pack. The current collector assembly includes a current collector and a conductive connection assembly, the current collector includes a plurality of tabs stacked in a thickness direction of the tab, the conductive connection assembly includes a protection plate and a connection plate, the protection plate is arranged on a side of the plurality of tabs in the thickness direction, the connection plate is arranged on the other side of the plurality of tabs in the thickness direction, a partial region of one of the connection plate and the protection plate is deformed to form a protrusion which, during the forming, pierces through the plurality of tabs to be electrically connected to the plurality of tabs.

### FIELD

The present disclosure relates to the field of battery technologies, and in particular, to a current collector assembly, a battery cell and a battery pack.

### BACKGROUND

In the related art, individual tabs are welded with copper foils welded on both sides of the composite tab by means of ultrasonic roll welding, and the welded copper foils are welded on soft connections. In this welding method, each tab needs to be welded, thus increasing the welding cost and the material cost of the copper foil. After welding, the welded sites are vulnerable to damage.

### SUMMARY

The present disclosure aims to solve at least one of the technical problems existing in the related art. Therefore, an object of the present disclosure is to provide a current collector assembly, which can reduce the welding difficulty of the tab, simplify the welding process of workers, reduce the manufacturing time, and reduce the labor cost.

The present disclosure also proposes a battery cell having the above current collector assembly.

The present disclosure also proposes a battery pack having the above battery cell.

The current collector assembly according to the present disclosure includes: a current collector including a plurality of tabs stacked in a thickness direction of each of the plurality of tabs; and a conductive connection assembly including a protection plate and a connection plate. The protection plate is arranged on a side of the plurality of tabs in the thickness direction. The connection plate is arranged on the other side of the plurality of tabs in the thickness direction. A partial region of one of the connection plate and the protection plate is deformed to form a protrusion which, during the forming, pierces through the plurality of tabs to be electrically connected to the plurality of tabs.

According to the current collector assembly of the present disclosure, by deforming a partial region of the protection plate or the connection plate to form the protrusion which, during the forming, pierces through the plurality of tabs, it is not necessary to process the protrusion in advance, thereby reducing the welding difficulty of the tab, simplifying the welding process of workers, reducing the manufacturing time, and reducing the labor cost.

According to some embodiments of the present disclosure, the partial region of the one of the connection plate and the protection plate is adapted to be deformed under an action of ultrasonic waves to form the protrusion.

According to some embodiments of the present disclosure, the protrusion is formed on the one of the connection plate and the protection plate, and the protrusion pierces through the plurality of tabs to be welded and fixed with the other one of the connection plate and the protection plate.

According to some embodiments of the present disclosure, a plurality of reinforcing grooves is defined in a welding region between the protrusion and the other one of the connection plate and the protection plate.

According to some embodiments of the present disclosure, a peeling force S between the protrusion and the other one of the connection plate and the protection plate is denoted by S, where 0.3 N/mm≤S≤2.5 N/mm.

According to some embodiments of the present disclosure, the protrusion is formed on the one of the connection plate and the protection plate, and at least a part of the protrusion has a cross-sectional area decreasing in a direction away from the one of the connection plate and the protection plate to form a piercing portion, and the piercing portion pierces through the plurality of tabs to be electrically connected to the plurality of tabs.

According to some embodiments of the present disclosure, the piercing portion is constructed in a shape of a pyramid or a shape of a prismoid.

According to some embodiments of the present disclosure, the one of the connection plate and the protection plate has a weld stamp provided thereon after the protrusion is formed, and the weld stamp is constructed in a polygonal shape.

According to some embodiments of the present disclosure, a plurality of protrusions is formed on the protection plate, the plurality of protrusions being arranged in a matrix.

According to some embodiments of the present disclosure, each of the plurality of tabs includes: a supporting insulation layer; and a first conductive layer and a second conductive layer that cover two side surfaces of the supporting insulation layer in a thickness direction of the supporting insulation layer, respectively.

According to the battery cell of the present disclosure, applying the above current collector assembly to the battery cell reduces the difficulty in assembling the battery cell, reduces the manufacturing time of the battery cell, reduces the labor cost, and guarantees the reliability of the battery cell.

According to the battery pack of the present disclosure, providing the above battery cell improves the safety performance of the battery pack, guarantees the reliability of the battery pack, and avoids the occurrence of danger.

Additional aspects and advantages of the present disclosure will be set forth, in part, from the following description, and in part will become apparent from the following description, or may be learned by practice of the present disclosure.

### BRIEF DESCRIPTION OF DRAWINGS

The above and/or additional aspects and advantages of the present disclosure will become apparent and readily understood from the following description of embodiments in conjunction with the accompanying drawings, in which:

FIG. 1 is a schematic diagram of a tab according to the present disclosure;

FIG. 2 is a cross-sectional view of a current collector assembly according to some embodiments of the present disclosure;

FIG. 3 is an enlarged schematic diagram of a local part shown by a circle A in FIG. 2;

FIG. 4 is a top view of a current collector assembly according to some embodiments of the present disclosure;

FIG. 5 is an enlarged schematic diagram of a local part shown by a circle B in FIG. 4;

FIG. 6 is a schematic diagram of a current collector assembly according to some other embodiments of the present disclosure;

FIG. 7 is an enlarged schematic diagram of a local part shown by a circle C in FIG. 6;

FIG. 8 is a cross-sectional view of a current collector according to some other embodiments of the present disclosure;

FIG. 9 is an enlarged schematic diagram of a local part shown by a circle D in FIG. 8;

FIG. 10 is a top view of a current collector according to still some other embodiments of the present disclosure; and

FIG. 11 is an enlarged schematic diagram of a local part shown by a circle E in FIG. 10.

Reference numerals: current collector assembly 100, current collector 110, tab 111, supporting insulation layer 111a, first conductive layer 111b, second conductive layer 111c, protection plate 121, connection plate 122, protrusion 123, piercing portion 123a, reinforcing groove 101.

### DESCRIPTION OF EMBODIMENTS

The embodiments of the present disclosure are described in detail below. Examples of the embodiments are shown in the accompanying drawings, throughout which the same or similar reference numerals indicate the same or similar elements or elements with the same or similar functions. The embodiments described below with reference to the accompanying drawings are exemplary, and are intended to explain the present disclosure, but should not be construed as limiting the present disclosure.

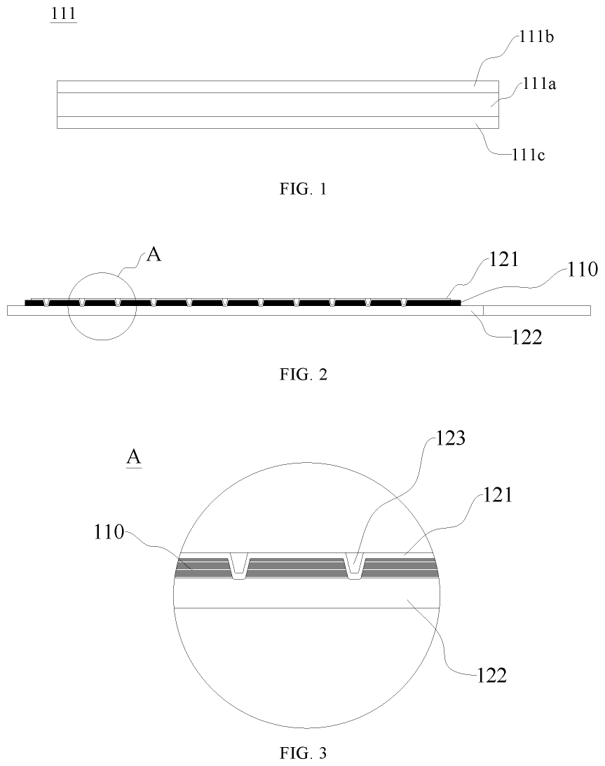

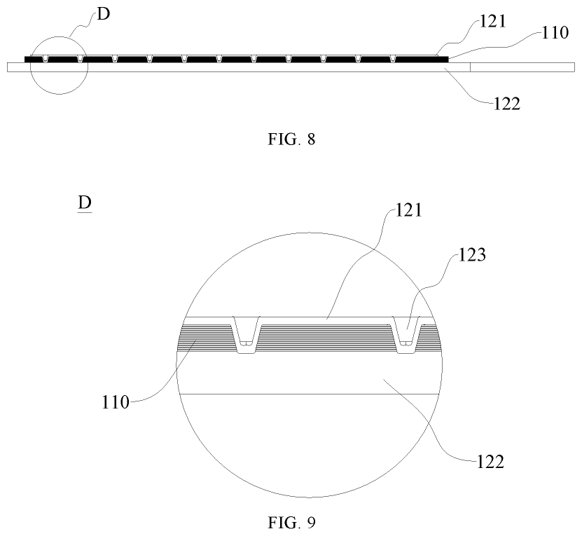

The current collector assembly 100 according to the embodiments of the present disclosure is described below with reference to FIGS. 1 to 11.

The current collector assembly 100 according to the embodiments of the present disclosure may include a current collector 110 and a conductive connection assembly.

Specifically, the current collector assembly 100 includes: a current collector 110 and a conductive connection assembly. The current collector 110 includes a plurality of tabs 111 stacked in a thickness direction of the tab 111. The conductive connection assembly includes a protection plate 121 (i.e., a welding plate) and a connection plate 122, the protection plate 121 is arranged on a side of the plurality of tabs 111 in the thickness direction, and the connection plate 122 is arranged on the other side of the plurality of tabs 111 in the thickness direction.

That is, the plurality of tabs 111 are stacked in the thickness direction of the tab 111, the protection plate 121 is arranged on a side of the plurality of tabs 111 in the thickness direction, and the connection plate 122 is arranged on the other side of the plurality of tabs 111 in the thickness direction. The plurality of tabs 111 is sandwiched by the protection plate 121 and the connection plate 122 in the thickness direction.

A partial region of one of the connection plate 122 and the protection plate 121 is deformed to form a protrusion 123, during the forming of which, the protrusion 123 pierces through the plurality of tabs 111 to be electrically connected to the plurality of tabs 111. When the protrusion 123 is formed on the connection plate 122, the protrusion 123 is formed on a side surface of the connection plate 122 facing towards the plurality of tabs 111 and extends towards the protection plate 121; when the protrusion 123 is formed on the protection plate 121, the protrusion 123 is formed on a side surface of the protection plate 121 facing towards the plurality of tabs 111 and extends toward the connection plate 122.

The protrusion 123 of the present disclosure is not initially disposed on the connection plate 122 or the protection plate 121, but a part of the protection plate 121 or the connection plate 122 is deformed by external force or external measures, and during the gradual forming of the protrusion 123, the plurality of tabs 111 are pierced by the protrusion 123. The protection plate 121 or the connection plate 122 of the present disclosure may be deformed by an action of ultrasonic welding to form the protrusion 123, and during the forming process of the protrusion 123, the protrusion 123 pierces through the plurality of tabs 111 to be electrically connected to the plurality of tabs 111.

In an up-down direction, the plurality of tabs 111 are stacked up, the protection plate 121 is located on an upper side of the plurality of tabs 111, the connection plate 122 is located on a lower side of the plurality of tabs 111, and the protrusion 123 is electrically connected to the tabs 111. When the protrusion 123 is formed on the protection plate 121, a welding device may act on the protection plate 121 to deform a partial region of the protection plate 121 downward to form the protrusion 123. The protrusion 123, during its formation, gradually penetrates through the plurality of tabs 111 from top to bottom to be electrically connected to the plurality of tabs 111.

According to the current collector assembly 100 of the embodiments of the present disclosure, the protrusion 123 is formed by deforming a partial region of the protection plate 121 or the connection plate 122, and the protrusion 123 pierces through the plurality of tabs 111 during its formation. Therefore, it is not necessary to process the protrusion 123 in advance, reducing the difficulty in welding the plurality of tabs 111, simplifying the welding process of workers, and reducing the production time and labor costs.

That is, the protrusion 123 in the present disclosure does not need to be formed on the protection plate 121 or the connection plate 122 in advance, but is formed and penetrates through the plurality of tabs 111 during the welding process, greatly reducing the production steps and simplifying the welding process.

In some embodiments of the present disclosure, the partial region of the one of the connection plate 122 and the protection plate 121 is adapted to be deformed under an action of ultrasonic waves to form the protrusion 123. That is, the protection plate 121 and the connection plate 122 in the current collector assembly 100 of the present disclosure are welded together by ultrasonic welding.

Specifically, during ultrasonic welding, the partial region of the connection plate 122 or the protection plate 121 is vibrated and deformed to form the protrusion 123. During the process of forming the protrusion 123, the protrusion 123 will pierce through the plurality of tabs 111 to be electrically connected to the plurality of tabs 111.

It should be noted that the one of the connection plate 122 and the protection plate 121 refers to a plate provided with the protrusion 123. When the protrusion 123 is provided on the protection plate 121, the one of the connection plate 122 and the protection plate 121 refers to the protection plate 121; and when the protrusion 123 is provided on the connection plate 122, the one of the connection plate 122 and the protection plate 121 refers to the connection plate 122.

The protrusion 123 is formed on one of the connection plate 122 and the protection plate 121, and the protrusion 123 is welded and fixed to the other one of the connection plate 122 and the protection plate 121 after piercing through the plurality of tabs 111. That is, when the protrusion 123 is formed on the protection plate 121, the protrusion 123 is welded and fixed to the connection plate 122 after piercing through the plurality of tabs 111 during the forming process; when the protrusion 123 is formed on the connection plate 122, the protrusion 123 is welded and fixed to the protection plate 121 after piercing through the plurality of tabs 111 during the forming process. The protrusion 123 may be welded and fixed to the other one of the connection plate 122 and the protection plate 121 after penetrating through the other one of the connection plate 122 and the protection plate 121, further increasing the welding stability.

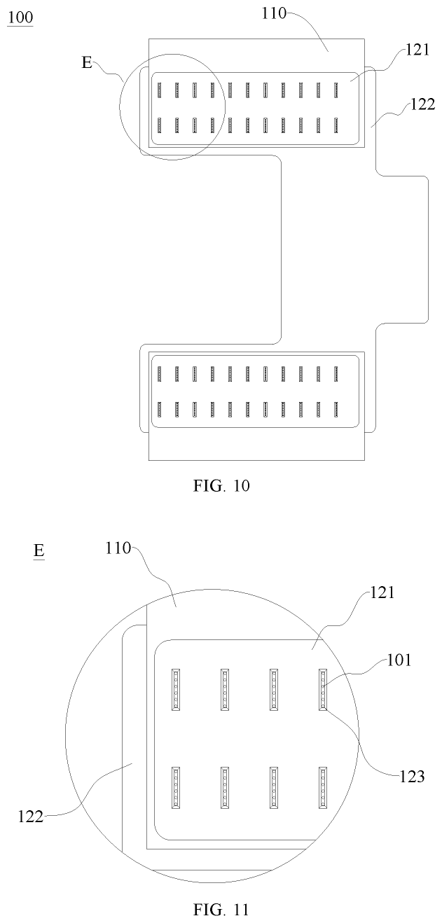

Further, as shown in FIG. 10 and FIG. 11, a plurality of reinforcing grooves 101 is defined in a welding region between the protrusion 123 and the other one of the connection plate 122 and the protection plate 121. That is, when the protrusion 123 is formed on the protection plate 121, a plurality of reinforcing grooves 101 is defined in a welding region between the protrusion 123 and the connection plate 122; and when the protrusion 123 is formed on the connection plate 122, a plurality of reinforcing grooves 101 is defined in a welding region between the protrusion 123 and the protection plate 121. As a result, a connection strength between the protrusion 123 and the connection plate 122 or the protection plate 121 is greatly increased, so that the protrusion 123 is not likely detached from the connection plate 122 or the protection plate 121, and thus the protrusion 123 is not likely detached from the plurality of tabs 111 to ensure connection stability between the plurality of tabs 111 and the protrusion 123.

Further, a peeling force S between the protrusion 123 and the other one of the connection plate 122 and the protection plate 121 satisfies: 0.3 N/mm≤S≤2.5 N/mm. In this way, the connection strength between the protrusion 123 and the connection plate 122 or the protection plate 121 is ensured, and at the same time, it is ensured that the pressing force is not too large that the processing process becomes difficult.

It should be noted that the above peeling force S refers to a force between the protrusion 123 and the other one of the connection plate 122 and the protection plate 121 after the welding of the protrusion 123 and the other one of the connection plate 122 and the protection plate 121 is completed.

In some embodiments of the present disclosure, the protrusion 123 is formed on one of the connection plate 122 and the protection plate 121, and at least a part of the protrusion 123 has a cross-sectional area gradually decreasing in a direction facing away from the one of the connection plate 122 and the protection plate 121 to form a piercing portion 123a, and the piercing portion 123a pierces through the plurality of tabs 111 to be electrically connected to the plurality of tabs 111. The piercing portion 123a may easily pierce through the plurality of tabs 111, and is electrically connected to the plurality of tabs 111 after the piercing.

Further, the piercing portion 123a is configured in a pyramid shape or a shape of a prismoid. As a result, the piercing portion 123a in a shape of a pyramid or a shape of a prismoid can easily penetrate through the plurality of tabs 111, improving the piercing capability of the protrusion 123.

When the piercing portion 123a is configured as a pyramid or a prismoid, the one of the connection plate 122 and the protection plate 121 further has a weld stamp provided thereon after the protrusion 123 is formed, and the weld stamp may be configured in a polygonal shape. It can be understood that a shape of the polygonal weld stamp is the same as a shape of the cross section of the pyramid or the prismoid. For example, when the weld stamp is a quadrilateral, the protrusion 123 is a quadrangular prism or a quadrangular pyramid.

Of course, it can be understood that the present disclosure does not limit the shape of the weld stamp and the shape of the cross section of the protrusion 123, as long as the piercing portion 123a of the protrusion 123 can pierce through the plurality of tabs 111 smoothly.

In some embodiments of the present disclosure, the protrusion 123 extends along a straight line and/or a curve on a surface of the connection plate 122 or the protection plate 121, and a section of the piercing portion 123a perpendicular to the extending direction of the protrusion 123 is formed as a triangle or a trapezoid. That is, the protrusion 123 may extend along a straight line on a surface of the connection plate 122, the protrusion 123 may alternatively extend along a curve on the surface of the connection plate 122, the protrusion 123 may alternatively extend along a curve on a surface of the protection plate 121, the protrusion 123 may alternatively extend along a straight line on the surface of the protection plate 121, the protrusion 123 may alternatively first extend along a straight line and then extend along a curve on the surface of the connection plate 122, or first extend along a curve and then extend along a straight line on the surface of the connection plate 122, or the protrusion 123 may alternatively first extend along a straight line and then extend along a curve on the surface of the protection plate 121, or first extend along a curve and then extend along a straight line on the surface of the protection plate 121. Thus, the welding requirements of different composite current collectors 110 are met, and the application range of the connecting piece is expanded.

When the section of the piercing portion 123a perpendicular to the extending direction is formed as a triangle, an angle of a piercing end in the section is not greater than 120°. That is, the protrusion 123 may be a prism. It is easier for the protrusion 123 with a triangular section to pierce through the plurality of tabs 111 of the current collector 110, so the piercing effect of the protrusion 123 may be guaranteed. Since the angle of the piercing end is not greater than 120°, the piercing effect of the protrusion 123 is further ensured, and the difficulty in welding the plurality of tabs 111 and the connecting piece is further reduced.

For example, in the section of the piercing portion 123a perpendicular to the extending direction, the angle of the piercing end may be 5°, 10°, 15°, 20°, 25°, 30°, 35°, 40°, 45°, 50°, 55°, 60°, 65°, 70°, 75°, 80°, 85°, 90°, 95°, 100°, 105°, 110°, 115°, 120°, and so on.

When the section of the piercing portion 123a perpendicular to the extending direction is formed as a trapezoid, a ratio of a length of an upper bottom of the section to a length of a lower bottom of the section is not greater than 0.6. That is, the piercing portion 123a may alternatively be a frustum of a pyramid, the piercing portion 123a may alternatively be a prism, or the piercing portion 123a may alternatively be a circular truncated cone. The lower bottom of the protrusion 123 is connected to the connecting piece, and the upper bottom of the protrusion 123 has a smaller size than the lower bottom of the protrusion 123, which guarantees the piercing effect of the protrusion 123. Since the ratio of the length of the upper bottom to the length of the lower bottom of the section is not greater than 0.6, the piercing effect of the protrusion 123 is further ensured and the difficulty in the welding of the tab 111 and the connecting piece is further reduced.

For example, the ratio of the length of the upper bottom to the length of the lower bottom of the section of the protrusion 123 may be 0.6, 0.55, 0.5, 0.45, 0.4, 0.35, 0.3, 0.25, 0.2, 0.15, 0.1, and so on.

In some embodiments, the length of the upper bottom of the section of the protrusion 123 is not greater than 3 mm, and the length of the lower bottom of the section of the protrusion 123 is not greater than 5 mm. For example, the length of the upper bottom of the section of the protrusion 123 may be 0.1 mm, 0.2 mm, 0.4 mm, 0.6 mm, 0.8 mm, 1.0 mm, 1.2 mm, 1.4 mm, 1.6 mm, 1.8 mm, 2.0 mm, 2.2 mm, 2.4 mm, 2.6 mm, 2.8 mm, 3.0 mm, and so on; and the length of the lower bottom of the section of the protrusion 123 may be 0.1 mm, 0.2 mm, 0.4 mm, 0.6 mm, 0.8 mm, 1.0 mm, 1.2 mm, 1.4 mm, 1.6 mm, 1.8 mm, 2.0 mm, 2.2 mm, 2.4 mm, 2.6 mm, 2.8 mm, 3.0 mm, 3.2 mm, 3.4 mm, 3.6 mm, 3.8 mm, 4.0 mm, 4.2 mm, 4.4 mm, 4.6 mm, 4.8 mm, 5.0 mm, and so on.

In some other embodiments of the present disclosure, the piercing portion 123a is formed in a cone shape or a shape of a circular truncated cone. That is, the piercing portion 123a may be in the cone shape, or the piercing portion 123a may be in the shape of a circular truncated cone.

When the piercing portion 123a is formed as a conical protrusion 123, a cone apex angle of the cone is greater than 5° and smaller than 150°, which is more conducive to balancing the connection strength and welding difficulty between the protrusion 123 and the plurality of tabs 111, avoiding a case in which the connection strength between the protrusion 123 and the plurality of tabs 111 is ensured but the difficulty of welding is increased, or a case in which the difficulty of welding is reduced but the connection strength between the protrusion 123 and the plurality of tabs 111 is reduced. In this way, the piercing effect of the protrusion 123 is ensured while the connection strength is improved.

For example, the cone apex angle of the cone may be 5°, 10°, 15°, 20°, 25°, 30°, 35°, 40°, 45°, 50°, 55°, 60°, 65°, 70°, 75°, 80°, 85°, 90°, 95°, 100°, 105°, 110°, 115°, 120°, 125°, 130°, 135°, 140°, 145°, 150°, and so on.

When the piercing portion 123a is formed in a shape of a circular truncated cone, a ratio of a radius of a top surface of the piercing portion 123a to a radius of a bottom surface of the piercing portion 123a is not greater than 0.6. That is, the top surface of the piercing portion 123a and a peripheral surface of the piercing portion 123a have a certain angle, and an area of the top surface of the piercing portion 123a is smaller than an area of the bottom surface of the piercing portion 123a. Therefore, it is easy for the top surface of the protrusion 123 to pierce through the plurality of tabs 111, which ensures the piercing effect of the protrusion 123, reduces the melting of the protrusion 123 during the welding process, and improves the reliability of the battery cell.

For example, the ratio of the radius of the top surface of the piercing portion 123a to the radius of the bottom surface of the piercing portion 123a may be 0.6, 0.55, 0.5, 0.45, 0.4, 0.35, 0.3, 0.25, 0.2, 0.15, 0.1, and so on.

In some embodiments, the radius of the top surface of the piercing portion 123a is not greater than 1.5 mm, and the radius of the bottom surface of the piercing portion 123a is not greater than 2.5 mm.

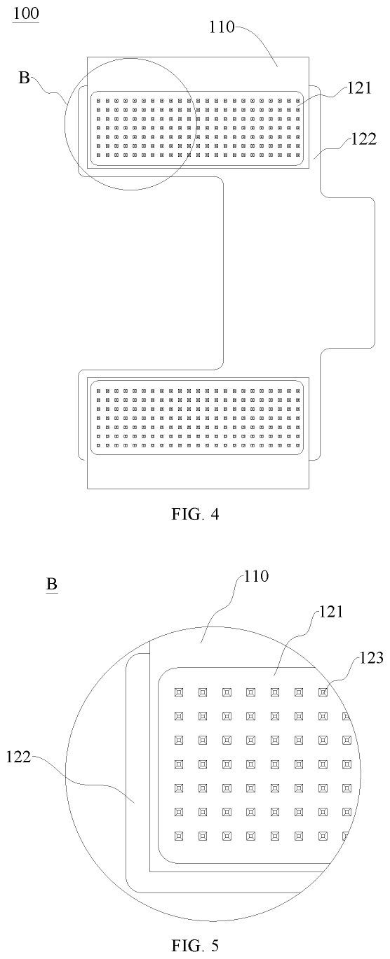

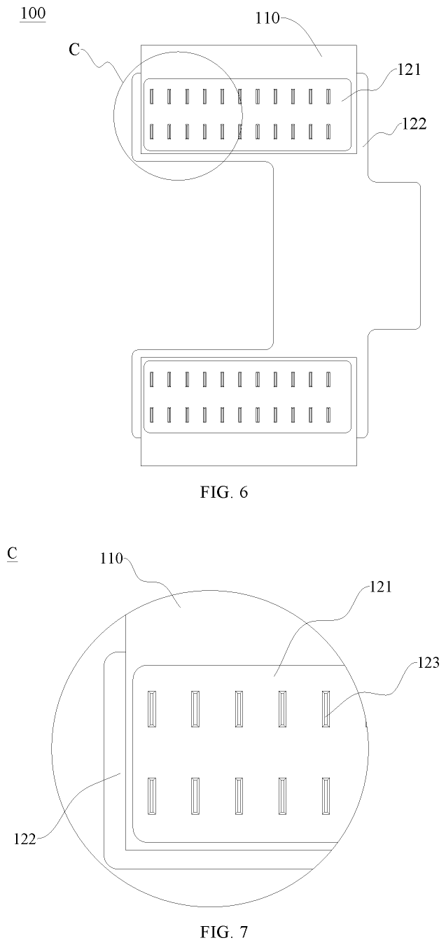

As shown in FIG. 4 and FIG. 5, the weld stamp is square, so the protrusion 123 is structured as a quadrangular prism. As shown in FIG. 6, FIG. 7, FIG. 10, and FIG. 11, the weld stamp is structured in a strip shape, so the protrusion 123 is also a strip-shaped quadrangular prism.

In some embodiments of the present disclosure, a plurality of protrusion 123 are provided and arranged in a matrix. The plurality of protrusion 123 arranged in an array improves the connection strength between the plurality of tabs 111 and the protrusions 123, prevents the plurality of tabs 111 and the protrusions 123 from detaching from each other during transportation or use, improves the yield of battery cells, and increases a contact area between the protrusions 123 and each of the plurality of tabs 111, and increases a current-passing area, so that heat dissipation is balanced, the battery pack is not prone to failure, the user danger is reduced, and the user experience is improved.

In some embodiments, the tab 111 includes: a supporting insulation layer 111a; and a first conductive layer 111b and a second conductive layer 111c that cover two side surfaces of the supporting insulation layer 111a in a thickness direction of the supporting insulation layer 111a, respectively. The supporting insulation layer 111a is located between the first conductive layer 111b and the second conductive layer 111c, and the first conductive layer 111b and the second conductive layer 111c cover an upper surface and a lower surface of the supporting insulation layer 111a, respectively.

Optionally, the supporting insulation layer 111a is a composite polymer insulation layer.

A current collector assembly 100 according to a specific embodiment of the present disclosure will be described below with reference to FIGS. 1 to 11.

The current collector assembly 100 according to the embodiment of the present disclosure includes a protection plate 121, a connection plate 122, and a current collector 110 disposed between the protection plate 121 and the connection plate 122. The current collector 110 includes a plurality of tabs 111. The protection plate 121 is located on a side of the plurality of tabs 111 in the thickness direction, and the connection plate 122 is located on the other side of the plurality of tabs 111 in the thickness direction.

Through an action of ultrasonic welding, a partial region of the protection plate 121 is deformed to form a protrusion 123, and during the forming of the protrusion 123, the protrusion 123 pierces through the plurality of tabs 111 to be electrically connected to the plurality of tabs 111. After the protrusion 123 penetrates through the plurality of tabs 111, a free end of the protrusion 123 also penetrates through the connection plate 122 and is welded and fixed to the connection plate 122. Further, in order to increase the connection strength between the protrusion 123 and the connection plate 122, a plurality of welding grooves are provided in a region where the protrusion 123 is connected to the connection plate 122 to ensure that the protrusion 123 is less likely to detach from the connection plate 122 or the plurality of tabs 111.

Further, at least a part of the protrusion 123 is constructed to have a cross-sectional area gradually decreasing in a direction approaching the connection plate 122, so that the protrusion 123 is formed to have a piercing portion 123a. The piercing portion 123a may be constructed in a shape of a pyramid or a shape of a prismoid. For example, a cross section of the piercing portion 123a may be triangular or polygonal.

The battery cell according to the embodiments of the second aspect of the present disclosure includes the current collector assembly 100 of the embodiments of the first aspect of the present disclosure.

According to the battery cell of the embodiments of the present disclosure, by applying the current collector assembly 100 of the embodiments of the first aspect to the battery cell, the difficulty in assembling the battery cell is reduced, the manufacturing time of the battery cell is shortened, the labor cost is reduced, and the reliability of the battery cell is ensured.

The battery pack according to the embodiments of the third aspect of the present disclosure includes the battery cell according to the embodiments of the second aspect of the present disclosure.

According to the battery pack of the embodiments of the present disclosure, by applying the battery cell of the embodiments of the second aspect, the safety performance of the battery pack is improved, the reliability of the battery pack is ensured, and the occurrence of danger is avoided.

Throughout this specification, description with reference to “an embodiment”, “some embodiments”, “illustrative embodiments”, “an example”, “a specific example”, or “some examples” means that a particular feature, structure, material, or characteristic described in connection with the embodiment or example is included in at least one embodiment or example of the present disclosure. The appearances of the above phrases in various places throughout this disclosure are not necessarily referring to the same embodiment or example of the present disclosure. Furthermore, the particular features, structures, materials, or characteristics described here may be combined in any suitable manner in one or more embodiments or examples.

Although embodiments of present disclosure have been shown and described above, it should be understood by those skilled in the art that various changes, modifications, alternatives, and variations can be made to the embodiments without departing from the principle and ideas of the present disclosure. The scope of the present disclosure is limited by the claims as attached and their equivalents.

What is claimed is:

1. A current collector assembly, comprising:
a current collector comprising a plurality of tabs stacked in a thickness direction of each of the plurality of tabs; and
a conductive connection assembly comprising a protection plate and a connection plate, wherein the protection plate is arranged on a side of the plurality of tabs in the thickness direction, and wherein the connection plate is arranged on the other side of the plurality of tabs in the thickness direction,
wherein a partial region of one of the connection plate and the protection plate is deformed to form a protrusion which, during the forming, pierces through the plurality of tabs to be electrically connected to the plurality of tabs.

2. The current collector assembly according to claim 1, wherein the partial region of the one of the connection plate and the protection plate is adapted to be deformed under an action of ultrasonic waves to form the protrusion.

3. The current collector assembly according to claim 1, wherein the protrusion is formed on the one of the connection plate and the protection plate, and the protrusion pierces through the plurality of tabs to be welded and fixed with the other one of the connection plate and the protection plate.

4. The current collector assembly according to claim 3, wherein a plurality of reinforcing grooves is defined in a welding region between the protrusion and the other one of the connection plate and the protection plate.

5. The current collector assembly according to claim 4, wherein a peeling force between the protrusion and the other one of the connection plate and the protection plate is denoted by S, where 0.3 N/mm≤S≤2.5 N/mm.

6. The current collector assembly according to claim 1, wherein the protrusion is formed on the one of the connection plate and the protection plate, and at least a part of the protrusion has a cross-sectional area decreasing in a direction away from the one of the connection plate and the protection plate to form a piercing portion, wherein the piercing portion pierces through the plurality of tabs to be electrically connected to the plurality of tabs.

7. The current collector assembly according to claim 6, wherein the piercing portion is constructed in a shape of a pyramid or a shape of a prismoid.

8. The current collector assembly according to claim 7, wherein the one of the connection plate and the protection plate has a weld stamp provided thereon after the protrusion is formed, wherein the weld stamp is constructed in a polygonal shape.

9. The current collector assembly according to claim 1, wherein a plurality of protrusions is formed on the protection plate, the plurality of protrusions being arranged in a matrix.

10. The current collector assembly according to claim 1, wherein each of the plurality of tabs comprises:
a supporting insulation layer; and
a first conductive layer and a second conductive layer that cover two side surfaces of the supporting insulation layer in a thickness direction of the supporting insulation layer, respectively.

11. A battery cell, comprising the current collector assembly according to claim 1.

12. The battery cell according to claim 11, wherein the partial region of the one of the connection plate and the protection plate is adapted to be deformed under an action of ultrasonic waves to form the protrusion.

13. The battery cell according to claim 11, wherein the protrusion is formed on the one of the connection plate and the protection plate, and the protrusion pierces through the plurality of tabs to be welded and fixed with the other one of the connection plate and the protection plate.

14. The battery cell according to claim 13, wherein a plurality of reinforcing grooves is defined in a welding region between the protrusion and the other one of the connection plate and the protection plate.

15. The battery cell according to claim 14, wherein a peeling force between the protrusion and the other one of the connection plate and the protection plate is denoted by S, where 0.3 N/mm≤S≤2.5 N/mm.

16. The battery cell according to claim 11, wherein the protrusion is formed on the one of the connection plate and the protection plate, and at least a part of the protrusion has a cross-sectional area decreasing in a direction away from the one of the connection plate and the protection plate to form a piercing portion, wherein the piercing portion pierces through the plurality of tabs to be electrically connected to the plurality of tabs.

17. The battery cell according to claim 16, wherein the piercing portion is constructed in a shape of a pyramid or a shape of a prismoid.

18. The battery cell according to claim 17, wherein the one of the connection plate and the protection plate has a weld stamp provided thereon after the protrusion is formed, wherein the weld stamp is constructed in a polygonal shape.

19. The battery cell according to claim 11, wherein a plurality of protrusions is formed on the protection plate, the plurality of protrusions being arranged in a matrix.

20. A battery pack, comprising the battery cell according to claim 11.
